(19) United States
(12) Patent Application Publication
(10) Pub. No.: US 2012/0320815 A1
(43) Pub. Date: Dec. 20, 2012

(54) Entity Identification Based on Proximity to Access Points

(75) Inventor: Jay Massena, Seattle, WA (US)

(73) Assignee: 3METERS LLC, Seattle, WA (US)

(21) Appl. No.: 13/323,024

(22) Filed: Dec. 12, 2011

Related U.S. Application Data
(60) Provisional application No. 61/422,559, filed on Dec. 13, 2010.

(51) Int. Cl. H04W 4/00

(52) U.S. Cl. 370/313

(57) ABSTRACT

Persons, places, events, things, concepts and services can be discovered, represented and identified based on proximity to network access points. The network access point can transmit data elements that can be used to construct an identifier. The identifier can be used to discover, identify and interact with entities based on proximity to one or more access point transmitters. One or more transmitters can represents one or more entities. Applications and other software on a device such as a mobile platform can include features that leverage information relating to the proximity and the identification of the entity or entities.

### CROSS-REFERENCE TO RELATED APPLICATIONS

This application claims priority to U.S. Provisional Application No. 61/422,559, filed Dec. 13, 2010, the disclosure of which is incorporated by reference in its entirety.

### BACKGROUND

Identifying entities such as persons, places, events, things, concepts and services can be based on bar codes, radio frequency identifiers (RFID), scanned pattern recognition, spatial coordinates based on latitude and longitude, etc. What is needed is a better way to discover entity identities easily, across a wide range of distances and using a wide variety of devices.

### BRIEF SUMMARY

In accordance with embodiments of the disclosed subject matter, network access points (such as 802.11 access points) can discover, represent and identify an entity's proximity to the access point. Examples of entities include persons, places, events, things, locations (e.g., map coordinates, latitude/longitude, or more generally as points in space expressed as two- or three-, or four-dimensional coordinates or any other suitable representation, etc.), concepts and services. The access point can transmit data elements to an entity receiver or transceiver (such as a smartphone, tablet, laptop, etc., hereinafter, an “entity device”) that can be used to construct an identifier that can be used to discover, identify and interact with entities based on proximity to the access point. Because the communication can be done using radio waves, embodiments of the disclosed subject matter can operate effectively through structures and can reflect around obstacles. The typical range can be several hundred feet.

An access point can be used to represent one or more entities that can be of different types. It can also move. For example, an access point can travel with an entity that does not always have a fixed location such as a performing group, a touring art exhibit, a cruise ship, a person, etc. It can be in an active or inactive mode (“activity mode”). For example, an access point can support an entity that has a time window such as a sporting event, festival event, or class session by becoming active during the event or session. Its activity mode can also be affected based on the location of the access point. For example, the access point can enter an active mode when the point is within certain geographic boundaries and enter an inactive mode when it is outside the boundaries. The activity mode can be changed when any suitable condition or set of conditions are satisfied.

Additional features, advantages, and embodiments of the disclosed subject matter may be set forth or are apparent from consideration of the following detailed description, drawings, and claims. Moreover, it is to be understood that both the foregoing summary and the following detailed description are exemplary and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate embodiments of the disclosed subject matter and together with the detailed description serve to explain the principles of embodiments of the disclosed subject matter. No attempt is made to show structural details in more detail than may be necessary for a fundamental understanding of the disclosed subject matter and various ways in which it may be practiced.

FIG. 1 shows a system according to an embodiment of the disclosed subject matter.

FIG. 2 shows an example process for identifying an entity according to an embodiment of the disclosed subject matter.

FIG. 3 shows an example process for finding entity associations according to an embodiment of the disclosed subject matter.

### DETAILED DESCRIPTION

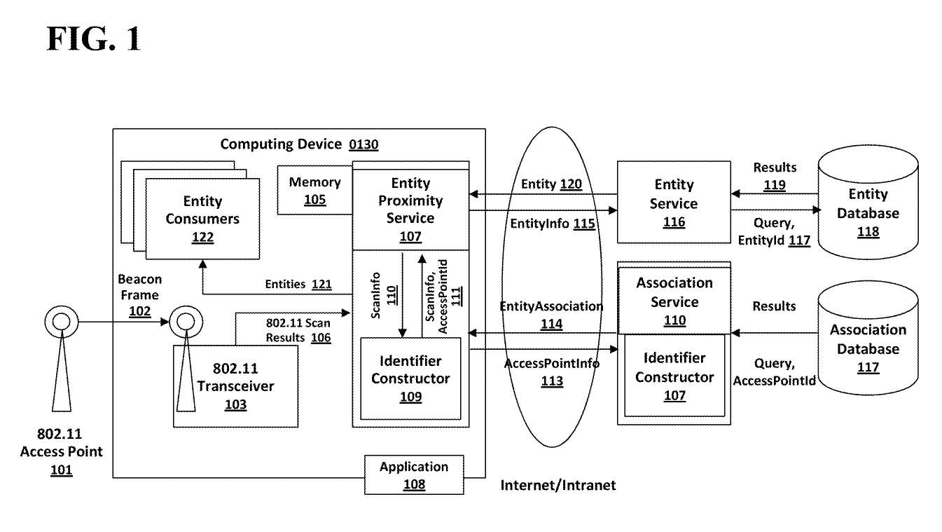

A system in accordance with the disclosed subject matter is shown in FIG. 1. Network access point 101 can transmit a signal (including, e.g., beacon frames) to entity device 102. Any suitable frame type can be used in accordance with embodiments of the disclosed subject matter, including a probe response frame, an association response frame, a reassociation response frame, etc. For example, a beacon frame can be transmitted at an interval of every tenth of a second. The beacon frame can be transmitted using any suitable protocol with or without security. It may include a set of data elements such as a 48 bit Basic Service Set Identifier (“BSSID”) that can be a Medium Access Control (MAC) address. This can be a unique address for the access point and can be used to negotiate and establish an association between the entity device receiving the beacon frame and the access point. The beacon frame may also contain a 32 character element Service Set Identifier (“SSID”). The SSID can be used to identify a specific wireless network that can include one or more access points. The SSID can be visible or be encrypted or otherwise obscured as a security measure.

Entity device 102 can include a transceiver 103 that can transmit and receive frames to and from access point 101. Communications between transceiver 103 and access point 101 can be via short range radio waves and can be based on an IEEE 802.11 specification, such as 802.11a, b, g, and/or n.

Transceiver 103 can communicate with entity processor 104, which can be in communication with entity memory 105. Processor 104 can process data such as a BSSID and/or a SSID received from transceiver 103 to produce a scan result 106. The scan result 106 can include one or more of the BSSID, SSID, signal strength data (e.g., in decibels), and other data. The scan result can be sent to an entity proximity service 107. The entity proximity service 107 can be implemented on the entity device 102 in whole or in part, or off of the entity device 102 in whole or in part. For example, entity proximity service 107 can be implemented partly or entirely on a server in communication with entity device 102 through a network such as a Local Area Network, a Wide Area Network, the Internet, or any other suitable communications medium. Entity memory 105 can include RAM, ROM, flash, hard disk or any other suitable memory that can store information electronically. Entity memory 105 can also store data as well as instructions adapted to be executed by entity processor 104 to perform functions in accordance with embodiments of the disclosed subject matter.

The entity proximity service 107 can use the received scan results 106 to determine an access point identifier (“APID”), e.g., using an identifier constructor 109. It can also identify one or more entities (if any) that may be currently associated with access point 101. Information about one or more of any identified access points 101 can be retrieved and used by proximity application 108, be presented to the entity device user, etc. Proximity application 108 can be located entirely on entity device 102, partly on entity device 102 and partly on another device (such as a server, other entity device, etc.) or entirely on another device. Entity proximity service 107 can create a ScanInfo object 110 that can include one or more properties, such as the following example properties:

Bssid: The BSSID from the scan results

Ssid: The SSID from the scan results

SignalDb: The signal strength of the access point transmission in decibels.

AccessPointId: An identifier for an access point (e.g., as set by the identifier constructor 109)

A call to the identifier constructor 109

Other properties relating to the access point 101.

The entity proximity service can pass the ScanInfo object 110 to the identifier constructor 109, which can construct an APID based on the ScanInfo object properties. It can set the AccessPointId property to the constructed APID and return the modified ScanInfo object 111 to the entity proximity service 107.

The entity proximity service 107 can call the association service 112 and pass it AccessPointInfo object 113. After the call is made to association service 112, the Entity Proximity Service 107 can receive back an EntityAssociation collection 114 based on matches with the AccessPointId. An access point 101 can have multiple EntityAssociations 114. If the set of EntityAssociations 114 is empty or null, there are currently no entities associated with the access point 101 identified with AccessPointId and the entity identification process stops.

The AccessPointInfo object 113 can include various properties, such as the following example properties:

AccessPointId: An access point identifier.

SignalDb: A signal strength of the access point transmission in decibels.

AccessPointTime: A date/time, which may be suitable for use for any time-based associations.

DeviceId: A unique identifier for a device within proximity of the access point 101.

UserId: A unique identifier for a user of the device.

RoleId: A unique identifier for a current role of a user of the device.

Other properties relating to the access point 101.

The EntityAssociation object 114 can include various properties, such as the following example properties:
AccessPointId: An access point identifier with which an entity is associated
EntityId: An identifier for an entity with which the access point 101 is associated
EntityStoreUri: A Uniform Resource Identifier (“URI”) for a network resource associated with an EntityId and that can provide an Entity object 120. A URI can be a Uniform Resource Identifier made up of a string of characters used to identify a resource on the Internet. Such identification can enable interaction with representations of the resource over a network (such as the Internet) using one or more protocols.
Other properties associated with the access point, entity, device, user, etc.

If the Association Service 112 returns one or more EntityAssociation objects 114, the entity proximity service 107 can create EntityInfo 115 objects for each. Each EntityInfo object 115 can be passed as part of a call to the Entity Service 116. The Entity Proximity Service 107 can receive back a set of one or more Entity objects 120 if the call is successful. If the set of Entity objects 115 is empty or null, the Entity Service 116 can have failed to find to have successfully created the Entity object(s) 120.

The EntityInfo object 115 can be used to lookup entities. Its properties can include, for example:
EntityId: An entity identifier.
EntityStoreUri: A Uniform Resource Identifier (“URI”) for a network resource associated with an EntityId and that can provide an Entity object 120.
IncludeRelatedEntities: A Boolean that can indicate whether to include entities that are related to the target entity including as a parent, child or sibling to the target entity.

The Entity object 120 can represent an entity. Its properties can include, for example:
EntityId: An identifier for the entity.
EntityType Collection: A field that can indicate an entity type, such as person, place, event, thing, concept, or the like. Types can define collections of things that share common properties. An entity can have multiple types.
EntityCreated field: A field that can indicate the date and time the entity record was created.
EntityOwner field: A field that can indicate one or more ownerships of the entity if appropriate.
EntityName field: A display name for the entity.
EntityAlias field: Aliases that can be alternate names for the entity.
EntityLocation field: An object property that can include the latitude and longitude for the entity, if appropriate.
EntityDescription: A description of the entity.
EntityImage: An image or reference to an image associated with the entity.
EntityWebpage: A webpage or reference to a webpage associated with the entity.
Extended Properties: Any additional properties appropriate to represent the EntityType.

In accordance with some embodiments of the disclosed subject matter, the properties described for the Entity object can apply to a simple base case. One skilled in the art will recognize that the set of properties could be modified with no loss of the spirit and scope of the disclosed subject matter.

If the Entity Proximity Service 107 process results in one or more Entity objects 120, the Entity objects 120 can be passed to any component or components that are acting as Entity Consumers 122. Entity Consumers 122 can be, for example, software components on the same entity device 102 and/or be on one or more remote computing devices.

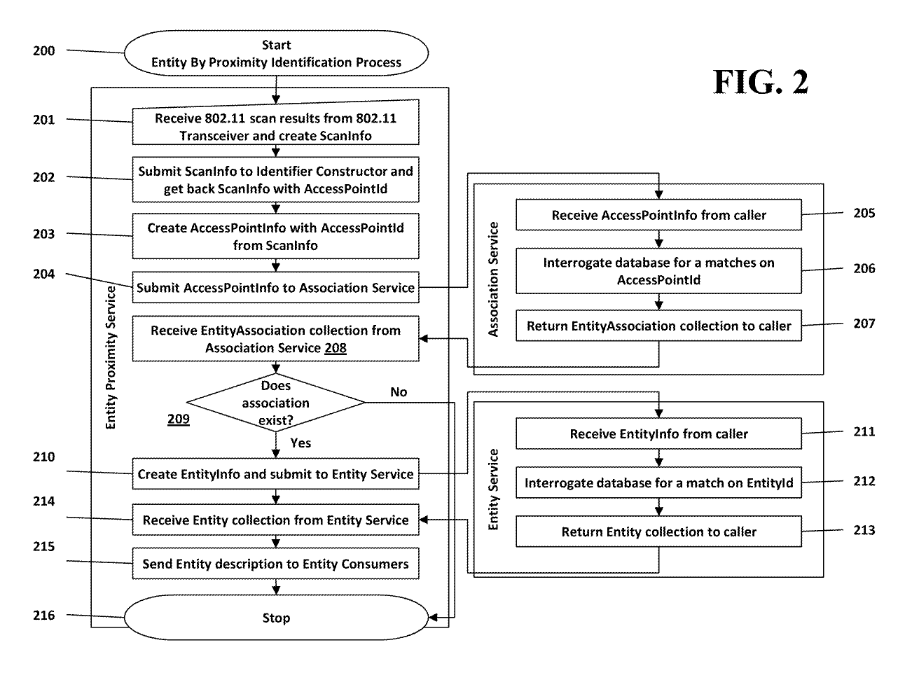

FIG. 2 shows an example process for identifying an entity in accordance with an embodiment of the disclosed subject matter. The Entity by proximity identification process is started 200 as scan results are received from the transceiver and a ScanInfo object is created 201. The ScanInfo object is submitted to the identifier constructor and the ScanInfo object and AccessPointId are returned 202. An AccessPointInfo object is created 203 based on the AccessPointId and AccessPointInfo is submitted to the association service 204.

The AccessPointInfo object is received at the association service 205, which queries one or more databases based on all or part of the AccessPointInfo 206. An EntityAssociation set is returned to the entity proximity service 207.

Upon receiving the EntityAssociation set 208, the entity proximity service determines if an association exists 209. If not, then the process stops 216. If an association is determines to exist, then the entity proximity service creates one or more EntityInfo objects and submits them to the entity service 210.

Upon receiving an EntityInfo object 211, the entity service queries at least one database based on the EntityInfo to identify any matches 212. The Entity set is returned to the entity proximity service 213.

Upon receiving the entity set 214, the entity proximity service sends an entity description to one or more entity consumers 215.

One skilled in the art will recognize that these steps may be rearranged and/or augmented with no loss of generality in the teachings of the disclosed subject matter, and that in some embodiments some steps may be omitted or replaced with similar or different steps.

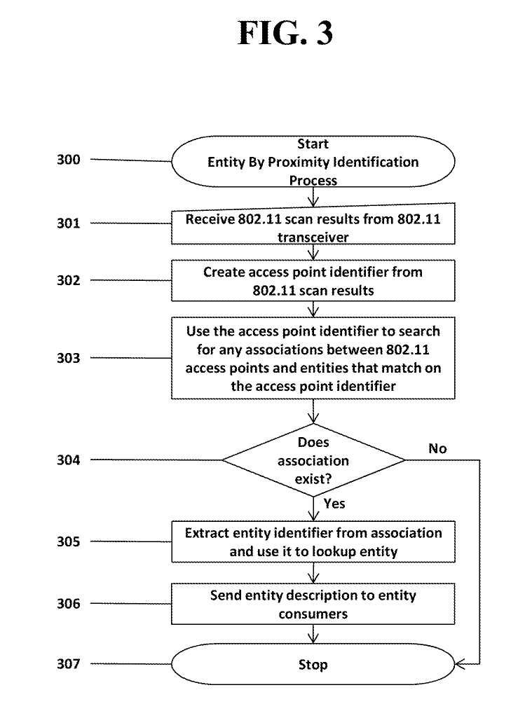

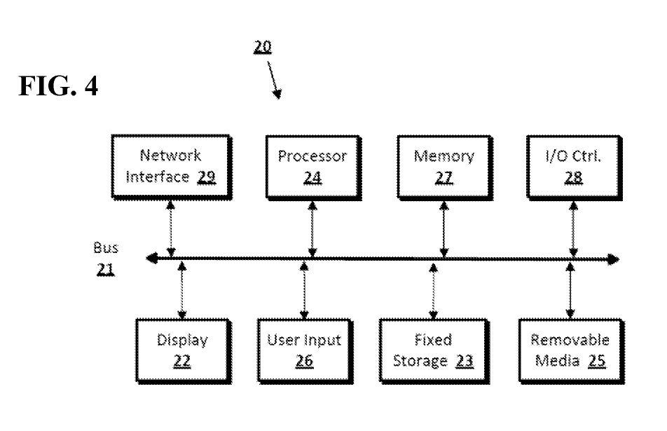

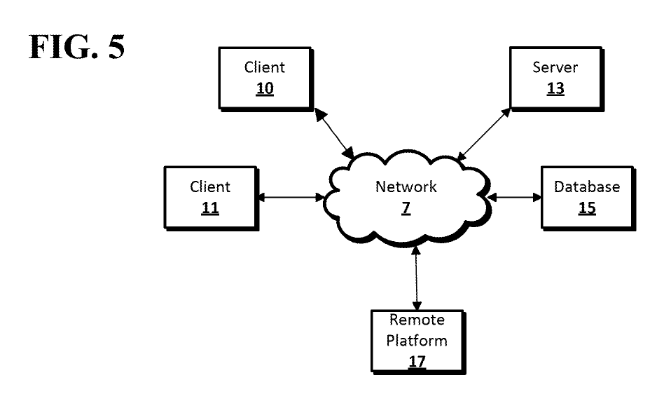

FIG. 3 shows an example process for finding entity associations in accordance with the disclosed subject matter. Scan results are received from a transceiver 301 and an access point identifier is created based on the received scan results 302. The access point identifier is used to search for any associations between one or more access points and any entity or entities based on the access point identifier 303. At 304, it may be determined whether such an association exists, and the process may stop if no association is determined. If an association is determined to exist, an entity identifier is extracted based on the determined association and used to lookup an entity 305. An entity description is sent to entity consumers 306.

The Identifier Constructor 109 can receive as an input a ScanInfo object 110. The property values of the ScanInfo object can be used to construct an access point identifier. The Identifier Constructor 109 can be used by the Entity Proximity Service 107 and any process that creates entity association records to implement a consistent method for access point identifier construction.

A method for constructing the access point identifier includes using the BSSID, such as, for the purposes of illustration only, 90:21:55:c8:16:23. Other methods for producing the access point identifier can include using the SSID, set to act as an access point identifier. An example of using the SSID as an access point identifier includes setting the SSID using a GUID (e.g., a 128 bit globally unique identifier). An illustrative example of a GUID: a4a71ce9-f664-4aa6-9a33-98ef46a73d4f. A composite of the BSSID and the SSID may also be used to construct the APID.

Further, elements from the ScanInfo object 110 can be combined with elements not included in the ScanInfo object 110. Examples can involve some other method for defining a domain such as the latitude and longitude, elevation, company name, or any other value that can serve as a domain.

The method used to construct the access point identifier can be any method that produces an access point identifier that can be used to associate entities with an access point 101. Whatever method is used can be shared among the Entity Proximity Service 107 and the process that creates entity association records.

The AccessPointId property of the ScanInfo object 110 that is passed to the Identifier Constructor 109 can be set to the constructed access point identifier and the modified ScanInfo object 110 can be returned to the caller, i.e., to an entity in communication with identifier constructor 110.

The Association Service 112 can be used to query associations in the Association Database 117 between an access point 101 and an Entity 120. It can also optionally support the ability to insert, update, delete or otherwise modify association records in the Association Database 117.

To discover any Entities 120 that are associated with the access point 101, the Association Service 112 can be called and passed an AccessPointInfo object 113 and an EntityAssociation set 114 can be returned. The EntityAssociation set 114 can be empty or null if there are no currently active associations between the access point 101 and an Entity 120.

The Association Service 112 can be an authority on whether an association exists between an access point 101 and an Entity 120. The association service 112 can query the association database for association records that correspond to the AccessPointId. EntityAssociation objects can be created from the results of the query.

Associations can be filtered based on (without limitation) properties of an AccessPointInfo object. For example, filtering can be done based on time window. If the AccessPointTime property does not fall within an active time period that can be specified for the association using AssociationStartTime and AssociationEndTime, it may not be returned to the caller. Filtering may also be accomplished based on proximity distance. For example, if a SignalDb value is not within a signal strength range specified for the association using AssociationStartSignaIDb and AssociationEndSignaIDb, it may not be returned to the caller. As another example, an association may be returned and flagged to be used if and when the signal strength exceeds a given threshold.

For filtering based on a specific device, if the DeviceId does not correspond to one or more AssociationDeviceIds that can be specified for the association, the association may not returned to the caller. For filtering based on a specific user, if the UserId does not correspond to one or more AssociationUserIds that can be specified for the association, the association may not be returned to the caller. Filtering can also be based on a specific role. If the RoleId does not correspond to one or more AssociationRoleIds that can be specified for the association, the association may not be returned to the caller.

Associations can be additionally filtered out if the AccessPointTime does not fall within the active time period for the association or the SignalDb is not within the valid signal strength range for the association. It will be understood by one of skill in the art that the specific filters and values disclosed herein are provided as examples only, and that in general any combination of filters and thresholds may be used.

The Association Service 112 creates at least one EntityAssociation object 114 for each active association that is returned in response to a query. The set or a subset of EntityAssociation objects 114 can be returned to the caller.

At times, an access point 101 may need to be changed but the existing associations with entities can be retained. The Association Service 112 can be called with a new access point identifier and an old access point identifier and perform an update that can change some or all of the references to the old access point identifier, e.g., by replacing it with an access point identifier associated with the new access point.

The Association Service can be called to insert a new association in the Association Database 117. The AccessPointId for the new association can be passed as part of the call or the Association Service 112 can call the Identifier Constructor 109 with a ScanInfo object 110 and receive in response a modified ScanInfo object 111 that can includes an AccessPointId property that includes at least one access point identifier. When a ScanInfo object 110 is created, the values required can be passed by the caller.

Association Database 117 can be a database with a query processor that can return one or more Association records in response to a query based on one or more AccessPointIds. The Association record can represent an association between an access point and an entity. It can include fields such as the following:
AssociationId: An identifier for one or more association records.
AccessPointId: An access point identifier.
EntityId: An entity identifier.
EntityStoreUri: A URI for an entity store that has the entity description. This can be a local entity store or a remote entity store.
AssociationStartTime: A time that can be used as a start time after which an association can be active.
AssociationEndTime: A time that can be used as an end time after which an association can become inactive.
AssociationStartSignaIDb: A signal strength (e.g., in decibels) below which an association can be active.
AssociationEndSignaIDb: A signal strength (e.g., in decibels) above which an association can be active.
AssociationDeviceId: An association can be active if this field (e.g., a MAC address) corresponds to an identifier of a calling device or another specified device
AssociationUserId: An association can be active if this field corresponds to an identifier of one or more users on behalf of whom a request is being made.
AssociationRoleId: An association can be active if this field corresponds to an identifier of one or more roles of one or more users on behalf of whom a request is being made.

The Entity Service 116 is a component that can receive a call that can include an EntityInfo object 115. It can execute a process to query the Entity Database 118 that can be identified by an EntityStoreUri for correspondence with EntityId.

The EntityStoreUri property can be a Uniform Resource Identifier (URI) for a resource on the Internet or Intranet that the Entity Service can call and pass the EntityId as a parameter and receive back an Entity object using whatever protocols are supported by the resource.

Upon obtaining a successful determination of correspondence by an Entity Database 118, the Entity Service 116 can construct and return an Entity object 120 to the caller. The IncludeRelatedEntities property of the EntityInfo object 115 can instruct the Entity Service 116 to include related entities in the results that are returned. Relationships include parent, child, and sibling.

The Entity Service 116 component can be hosted on the same computing device as the Association Service 112 and/or the Entity Proximity Service 107 or as a service running on a different computing device that is reachable by Internet or Intranet.

The Entity Database 118 may be a database with a query processor that can return one or more Entity records based on a match on an EntityId. It can also execute a query to return any entities that are related to a target entity either as a parent, a child or as a sibling.

An Entity record presents an entity and can include fields such as the following:
EntityId: An identifier for the entity.
EntityType: A field that can indicate an entity type, such as person, place, event, thing, concept, or the like. Types can define collections of things that share common properties. An entity can have multiple types.
EntityCreated: A field that can indicate the date and time the entity record was created.
EntityOwner: A field that can indicate one or more ownership of the entity if appropriate.
EntityName: A field that can include a display name for the entity.
EntityAlias: A field that can include aliases that are alternate names for the entity.
EntityLocation: An object property that can include the latitude and longitude for the entity if appropriate.
EntityDescription: A description of the entity.
EntityImage: An image or reference to an image associated with the entity.
EntityWebpage: A webpage or reference to a webpage associated with the entity.
Extended fields: Additional fields that can be included as appropriate to represent the properties that apply based on the type of entity being stored.

A join table can be used to model relationships between entities in the database. Additional tables can be used to support entity properties that are collections or act as objects. The entity can be stored in a single table or normalized across multiple tables.

The Entity Database 118 can support the following capabilities, among others:
Insert a new record.
Update an existing record.
Delete an existing record.
Return a record or records based on a query.

The Entity Database 118 can be any storage mechanism that is capable of storing the equivalent of a record with multiple fields. Entity Database 118 can store data in a node and link based graph database, as structured text such as comma separated values, as XML files in a folder or in any other suitable format and mechanism.

The access point identifier is used as part of creating a virtual association between an access point 101 and an Entity 120. The access point identifier can also be used as the entity identifier so that no mapping is needed. There can also be a mapping chain that involves multiple associations to transit from the access point identifier to the entity identifier.

The components described herein (e.g., transceiver 103, entity proximity service 107, entity service 116, etc.) can be combined on a single computing device or distributed across multiple computing devices in accordance with various embodiments of the disclosed subject matter.

Embodiments of the presently disclosed subject matter may be implemented in and used with a variety of component and network architectures. FIG. 4 is an example computer 20 suitable for implementing embodiments of the presently disclosed subject matter. The computer 20 includes a bus 21 which interconnects major components of the computer 20, such as a central processor 24, a memory 27 (typically RAM, but which may also include ROM, flash RAM, or the like), an input/output controller 28, a user display 22, such as a display screen via a display adapter, a user input interface 26, which may include one or more controllers and associated user input devices such as a keyboard, mouse, and the like, and may be closely coupled to the I/O controller 28, fixed storage 23, such as a hard drive, flash storage, Fibre Channel network, SAN device, SCSI device, and the like, and a removable media component 25 operative to control and receive an optical disk, flash drive, and the like. The bus 21 allows data communication between the central processor 24 and the memory 27, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) that controls basic hardware operation such as the interaction with peripheral components. Applications resident with the computer 20 are generally stored on and accessed via a computer readable medium, such as a hard disk drive (e.g., fixed storage 23), an optical drive, floppy disk, or other storage medium 25.

The fixed storage 23 may be integral with the computer 20 or may be separate and accessed through other interfaces. A network interface 29 may provide a direct connection to a remote server via a telephone link, to the Internet via an Internet Service Provider (ISP), or a direct connection to a remote server via a direct network link to the Internet via a POP (point of presence) or other technique. The network interface 29 may provide such connection using wireless techniques, including digital cellular telephone connection, Cellular Digital Packet Data (CDPD) connection, digital satellite data connection or the like. For example, the network interface 29 may allow the computer to communicate with other computers via one or more local, wide-area, or other networks, as shown in FIG. 4.

Many other devices or components (not shown) may be connected in a similar manner (e.g., document scanners, digital cameras and so on). Conversely, all of the components shown in FIG. 4 need not be present to practice the present disclosure. The components can be interconnected in different ways from that shown. The operation of a computer such as that shown in FIG. 4 is readily known in the art and is not discussed in detail in this application. Code to implement the present disclosure can be stored in computer-readable storage media such as one or more of the memory 27, fixed storage 23, removable media 25, or on a remote storage location.

FIG. 5 shows an example network arrangement according to an embodiment of the disclosed subject matter. One or more clients 10, 11, such as local computers, smart phones, tablet computing devices, and the like may connect to other devices via one or more networks 7. The network may be a local network, wide-area network, the Internet, or any other suitable communication network or networks, and may be implemented on any suitable platform including wired and/or wireless networks. The clients may communicate with one or more servers 13 and/or databases 15. The devices may be directly accessible by the clients 10, 11, or one or more other devices may provide intermediary access such as where a server 13 provides access to resources stored in a database 15. The clients 10, 11 also may access remote platforms 17 or services provided by remote platforms 17 such as cloud computing arrangements and services. The remote platform 17 may include one or more servers 13 and/or databases 15.

More generally, various embodiments of the presently disclosed subject matter may include or be embodied in the form of computer-implemented processes and apparatuses for practicing those processes. Embodiments also may be embodied in the form of a computer program product having computer program code containing instructions embodied in non-transitory and/or tangible media, such as floppy diskettes, CD-ROMs, hard drives, USB (universal serial bus) drives, or any other machine readable storage medium, wherein, when the computer program code is loaded into and executed by a computer, the computer becomes an apparatus for practicing embodiments of the disclosed subject matter. Embodiments also may be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing embodiments of the disclosed subject matter. When implemented on a general-purpose microprocessor, the computer program code segments configure the microprocessor to create specific logic circuits. In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Embodiments may be implemented using hardware that may include a processor, such as a general purpose microprocessor and/or an Application Specific Integrated Circuit (ASIC) that embodies all or part of the techniques according to embodiments of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to embodiments of the disclosed subject matter.

The foregoing description and following appendices, for purpose of explanation, have been described with reference to specific embodiments. However, the illustrative discussions above are not intended to be exhaustive or to limit embodiments of the disclosed subject matter to the precise forms disclosed. Many modifications and variations are possible in view of the above teachings. The embodiments were chosen and described in order to explain the principles of embodiments of the disclosed subject matter and their practical applications, to thereby enable others skilled in the art to utilize those embodiments as well as various embodiments with various modifications as may be suited to the particular use contemplated.

1. A method comprising:
receiving data from a wireless transmitter;
generating an access point identifier based upon the data received from the wireless transmitter;
storing a record in a data store, the record associating an entity with the wireless transmitter, the access point identifier, or both the wireless transmitter and the access point identifier;
responsive to a request received from a requestor, the request including the access point identifier, searching the data store to identify the entity; and
providing information about the entity to a requestor.

2. A method according to claim 1, wherein the wireless transmitter is compatible with an IEEE 802.11 wireless communication standard.

3. A method according to claim 1, wherein the data received from the wireless transmitter comprises one or more frames as defined by an IEEE 802.11 wireless communication standard.

4. A method according to claim 1, wherein the information provided about the entity comprises an entity type, an owner of the entity, a name of the entity, an alternate name of the entity, a location of the entity, a text description of the entity, an image associated with the entity, a network address associated with the entity, a website associated with the entity, or a combination thereof.

5. A method according to claim 1, further comprising:
determining that information about the entity stored in a data store is obsolete; and
updating the information about the entity stored in the data store prior to providing the information about the entity to the requestor.

6. A method according to claim 1, further comprising:
receiving a plurality of access point identifiers and initial information about a plurality of entities; and
for each received access point identifier, storing a record in the data store associating the access point identifier and a portion of the initial information relating to an entity associated with the access point identifier.

7. A method comprising:
receiving information describing the presence of one or more wireless network access points in a region;
based upon the received information, identifying one or more wireless access points in the region;
generating an access point identifier for each identified wireless access point;
submitting each generated access point identifier to an association service;
receiving entity association data from the association service;
for each access point identifier indicated as having an association with an entity according to the entity association data received from the association service, generating an entity information data entry;
submitting each generated entity information data entry to an entity service;
receiving an entity description for at least one entity associated with at least one of the wireless network access points; and
providing the entity description to a requestor.

8. A method according to claim 7, further comprising, at the association service:
receiving each generated access point identifier;
searching a data store for each received access point identifier; and
for each access point identifier found in the data store, providing an indication of an associated entity in the entity association data.

9. A method according to claim 7, further comprising, at the entity service;
receiving the generated entity information data;
searching a data store for each entity identified in the received entity information data; and
for each entity found in the data store, providing the entity description for the at least one entity associated with the at least one of the wireless network access points.

10. A method according to claim 7, wherein each of the one or more wireless access points is compatible with an IEEE 802.11 wireless communication standard.

11. A method according to claim 7, wherein the entity description comprises an entity type, an owner of the entity, a name of the entity, an alternate name of the entity, a location of the entity, a text description of the entity, an image associated with the entity, a network address associated with the entity, a website associated with the entity, or a combination thereof.

12. A system comprising:
a receiver configured to receive data from a wireless transmitter;
a computer readable storage medium;
a processor configured to:
generate an access point identifier based upon the data received from the wireless transmitter;
store a record in the computer readable storage medium, the record associating an entity with the wireless transmitter, the access point identifier, or both the wireless transmitter and the access point identifier; and
responsive to a request received from a requestor, the request including the access point identifier, searching the data store to identify the entity; and
an output configured to provide information about the entity to a requestor.

13. A system according to claim 12, wherein the wireless transmitter is compatible with an IEEE 802.11 wireless communication standard.

14. A system according to claim 12, wherein the receiver is compatible with an IEEE 802.11 wireless communication standard.

15. A system according to claim 12, wherein the data received from the wireless transmitter comprises one or more frames as defined by an IEEE 802.11 wireless communication standard.

16. A system according to claim 12, wherein the information provided about the entity comprises an entity type, an owner of the entity, a name of the entity, an alternate name of the entity, a location of the entity, a text description of the entity, an image associated with the entity, a network address associated with the entity, a website associated with the entity, or a combination thereof.

17. A system according to claim 12, said processor further configured to:
determine that information about the entity stored in a data store is obsolete; and
update the information about the entity stored in the computer readable storage medium prior to providing the information about the entity to the requestor.

18. A system according to claim 12, said processor further configured to:
Receive a plurality of access point identifiers and initial information about a plurality of entities; and
for each received access point identifier, store a record in the computer readable storage medium associating the access point identifier and a portion of the initial information relating to an entity associated with the access point identifier.

19. A system comprising:
a receiver configured to receive information describing the presence of one or more wireless network access points in a region;
a processor configured to:
identify one or more wireless access points in the region based upon the received information;
generate an access point identifier for each identified wireless access point;
submit each generated access point identifier to an association service;
receive entity association data from the association service;
for each access point identifier indicated as having an association with an entity according to the entity association data received from the association service, generate an entity information data entry;
submit each generated entity information data entry to an entity service; and
receive an entity description for at least one entity associated with at least one of the wireless network access points; and
an output configured to provide the entity description to a requestor.

20. A system according to claim 19, wherein each of the one or more wireless access points is compatible with an IEEE 802.11 wireless communication standard.

21. A system according to claim 19, wherein the entity description comprises an entity type, an owner of the entity, a name of the entity, an alternate name of the entity, a location of the entity, a text description of the entity, an image associated with the entity, a network address associated with the entity, a website associated with the entity, or a combination thereof.

22. A non-transitory computer readable storage medium storing a plurality of instructions that cause a processor to perform a method comprising:
receiving data from a wireless transmitter;
generating an access point identifier based upon the data received from the wireless transmitter;
storing a record in a data store, the record associating an entity with the wireless transmitter, the access point identifier, or both the wireless transmitter and the access point identifier;
responsive to a request received from a requestor, the request including the access point identifier, searching the data store to identify the entity; and
providing information about the entity to a requestor.

23. A non-transitory computer readable storage medium storing a plurality of instructions that cause a processor to perform a method comprising:
receiving information describing the presence of one or more wireless network access points in a region;
based upon the received information, identifying one or more wireless access points in the region;
generating an access point identifier for each identified wireless access point;
submitting each generated access point identifier to an association service;
receiving entity association data from the association service;
for each access point identifier indicated as having an association with an entity according to the entity association data received from the association service, generating an entity information data entry;
submitting each generated entity information data entry to an entity service;
receiving an entity description for at least one entity associated with at least one of the wireless network access points; and
providing the entity description to a requestor.
